(19) United States
(12) Patent Application Publication
(10) Pub. No.: US 2022/0186526 A1
(43) Pub. Date: Jun. 16, 2022

(54) ROTARY CYLINDER ASSEMBLY

(71) Applicant: Dezhao XIANG, Guangdong (CN)

(72) Inventors: Dezhao XIANG, Guangdong (CN); Qiuzhi YANG, Guangdong (CN)

(21) Appl. No.: 17/118,620

(22) Filed: Dec. 11, 2020

(51) Int. Cl. E05B 63/00; E05B 15/00; E05B 1/00

(52) U.S. Cl. CPC E05B 63/0056; E05B 1/0053; E05B 15/0033

(57) ABSTRACT

A rotary cylinder assembly, including a rotary cylinder housing assembly and a spindle transmission assembly, wherein the spindle transmission assembly is arranged on one side of a latch or used individually; and a rotary cylinder housing assembly is arranged at the other end of the spindle transmission assembly and configured to drive the spindle transmission assembly under an external force to rotate to realize deadlocking. The rotary cylinder assembly drives the spindle transmission assembly by driving the rotary cylinder housing assembly to toggle the latch toggling sleeve to drive a bolt of the latch to extend, or drives a toggling adaptor of the spindle transmission assembly to directly hook or clamp a certain fixed part of a to-be-locked object, thereby realizing keyless mechanical deadlocking of the mechanical deadbolt lock.

### BACKGROUND OF THE INVENTION

The present invention relates to the fields of a cylinder and application thereof, and in particular, to a rotary cylinder assembly.

Locks refer to appliances for closing and are widely applied to every family, commerce, office places, communal facility places and the like.

A complete mechanical lock includes a latch, a cylinder and a key.

Nowadays, the widely used mechanical deadbolt lock can only be locked by the key, which is very inconvenient for the elderly, children, the disabled, people holding babies and people with inconvenient hands.

How to realize keyless locking of the mechanical deadbolt lock has become a technical problem to be solved urgently.

### BRIEF SUMMARY OF THE INVENTION

### (I) Invention Objectives

To solve the technical problems in the background art, the present invention provides a rotary cylinder assembly. The present invention is favorable for a rotary cylinder housing assembly to drive a spindle transmission assembly to realize mechanical keyless locking.

### (II) Technical Solutions

To solve the above problem, the present invention provides a rotary cylinder assembly, including:
a rotary cylinder assembly, arranged on one side of a latch or used individually;
a spindle transmission assembly, arranged on one side of the latch or one part of a to-be-locked object; and
a rotary cylinder housing assembly, arranged at the other end of the spindle transmission assembly and configured to drive the spindle transmission assembly under an external force to rotate and drive the latch or the toggling sheet to hook or clamp a certain fixed part of the to-be-locked object.

Preferably, the rotary cylinder assembly includes:
a rotary cylinder housing assembly and a spindle transmission assembly.

Preferably, the rotary cylinder assembly includes:
the rotary cylinder assembly may be used together with the latch to toggle the latch toggling sleeve by the toggling sheet to drive the bolt to extend to lock the door; and the rotary cylinder assembly may be used individually to clamp or hook a certain part of the fixed part of the locked objected by the toggling sheet without the latch to realize a dead-locking function.

Preferably, the latch includes: a latch toggling sleeve, a latch shell and a bolt.

Preferably, the rotary cylinder housing assembly further includes:
a rotary cylinder housing, arranged at one end of a spindle rotating part and detachably and fixedly connected to a rotary body.

Preferably, the rotary cylinder housing may be used individually.

Preferably, a structure of the rotary body may be any one of a rotary knob, a button, a handle, a pull handle, a lever, a gear and a zipper; and a shape of the rotary body may be any one of a square shape, a round shape, a conical shape, a trapezoidal shape, a rod shape, a spherical shape, a needle shape, a triangular shape and a column shape.

Preferably, the rotary body and the rotary cylinder housing may be in the form of a fixed structure.

Preferably, the rotary body and the rotary cylinder housing may be in the form of a detachable connection structure, and a structure may be any one of plug type structure connection, lever type structure connection, plug-pin type structure connection, chain type structure connection and screw fastening type connection.

Preferably, the spindle transmission assembly includes: a spindle rotating part and a spindle toggling sheet.

Preferably, the spindle rotating part may be used individually, and the spindle rotating part and the rotary cylinder housing are detachably connected.

Preferably, the spindle rotating part may also be detachably connected to other objects and then be connected to the spindle toggling sheet.

Preferably, a shape of the spindle rotating part may be any one of a strip shape, a square shape, a diamond shape, a conical shape, a trapezoidal shape, a rod shape, a spherical shape, a needle shape, a triangular shape and a column shape.

Preferably, a connection structure of the spindle rotating part and the rotary cylinder housing may be any one of a plug type structure, a screw cap type structure, a lever type structure, a plug-pin type structure, a chain type structure, a stop opening type structure, a clamping opening type structure, a thimble type structure, a gear type structure and a screw fastening type structure.

Preferably, the spindle toggling sheet may be of different shapes and may be detachably and fixedly connected to the spindle rotating part directly.

Preferably, a connection structure of the spindle toggling sheet and the spindle rotating part may be any one of an abutting type structure, a plug type structure, a screw cap type structure, a lever type structure, a plug-pin type structure, a chain type structure, a stop opening type structure, a clamping opening type structure, a thimble type structure, a gear type structure and a screw fastening type structure.

Preferably, a shape of the spindle toggling sheet when the spindle toggling sheet drives the latch toggling sleeve may be any one of a strip shape, a rectangular shape, a square shape, a round shape, a conical shape, a trapezoidal shape, a rod shape, a spherical shape, a needle shape, a triangular shape and a column shape.

Preferably, a connection mode when the spindle toggling sheet drives the latch toggling sleeve may be any one of a penetrating type structure, a thimble structure, a rubbing and clinging structure, a lever prizing structure, a bearing structure, a force return structure, a zipper structure and a gear structure; and a driving mode when the spindle toggling sheet drives the latch toggling sleeve may be any one of a push-out type, a sliding type, a bouncing type, a prizing type, a push type, a pull type, a rotating type, a toggling type, a toggling tooth type, a zipper type, a gear type and a twisting type.

The above technical solution of the present invention has the following beneficial technical effects:

Through rotation of the rotary knob, the rotary knob may continuously rotate under the continuous action of an external twisting force, so as to drive the spindle to rotate; and through a driving torque of the spindle, the bolt can be driven to move close to a direction of a lockhole to complete dead-locking operation.

### BRIEF DESCRIPTION OF THE DRAWINGS

FIG. 1 is a schematic structural diagram of a rotary cylinder assembly according to the present invention.

In the drawings:

1 rotary cylinder housing assembly: rotary cylinder housing assembly and spindle transmission assembly, wherein

rotary cylinder housing assembly: 1.1 rotary cylinder housing, 1.2 rotary body;

spindle transmission assembly: 1.3 spindle rotating part, 1.4 spindle toggling sheet;

2 latch: 2.2 latch toggling sleeve, 2.3 bolt.

### DETAILED DESCRIPTION OF THE INVENTION

For clearer descriptions of the objectives, technical solutions, and advantages of the present invention clearer, the present invention is further described hereinafter in detail with reference to the specific embodiments and the accompanying drawings. It should be understood that the descriptions are merely exemplary, but are not intended to limit the scope of the present invention. In addition, in the following description, descriptions of conventional structures and technologies are omitted to avoid unnecessarily confusing the concepts of the present invention.

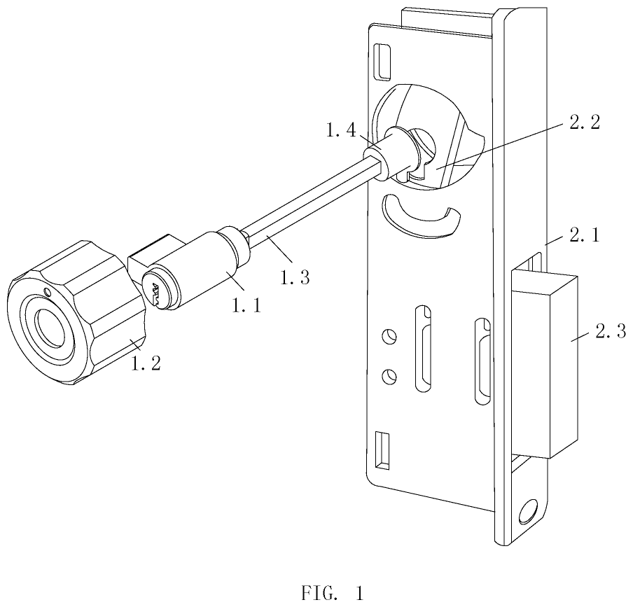

As shown in FIG. 1, a rotary cylinder assembly provided by the present invention includes:
a rotary cylinder assembly 1, arranged on one side of a latch 2 or used individually;
a spindle transmission assembly 1.3 and 1.4, arranged at one end of the latch 2 or one part of a to-be-locked object; and
a rotary cylinder housing assembly 1.1 and 1.2, arranged at the other end of the spindle transmission assembly 1.3 and 1.4 and configured to drive the spindle transmission assembly 1.3 and 1.4 under an external force to rotate and drive the latch 2 or hook or clamp a certain fixed part of the to-be-locked object by a toggling sheet.

In one optional embodiment, the rotary cylinder assembly 1 includes:
a rotary cylinder housing assembly 1.1 and 1.2 and a spindle transmission assembly 1.3 and 1.4.

In one optional embodiment, the rotary cylinder assembly includes:
the rotary cylinder assembly may be used together with the latch to toggle the latch toggling sleeve by the toggling sheet to drive the bolt to extend to lock the door; and the rotary cylinder assembly may be used individually to clamp or hook a certain part of the fixed part of the locked objected by the toggling sheet without the latch to realize a dead-locking function.

In one optional embodiment, the latch 2 includes: a latch toggling sleeve 2.2 and a bolt 2.3.

In one optional embodiment, the rotary cylinder housing assembly further includes:
a rotary cylinder housing 1.1, arranged at one end of the spindle rotating part 1.3 and detachably and fixedly connected to the rotary body 1.2.

In one optional embodiment, the rotary cylinder housing 1.1 may be used individually.

In one optional embodiment, a shape of the rotary body 1.2 may be any one of a square shape in the form of a rotary knob, a handle, a lever, a zipper and the like, a round shape, a round shape, a conical shape, a trapezoidal shape, a rod shape, a spherical shape, a needle shape, a triangular shape and a column shape.

In one optional embodiment, the rotary body 1.2 and the rotary cylinder housing 1.1 may be in the form of a fixed structure.

In one optional embodiment, the rotary body 1.2 and the rotary cylinder housing 1.1 may be in the form of a detachable connection structure, and a structure may be any one of plug type structure connection, lever type structure connection, plug-pin type structure connection, chain type structure connection and screw fastening type connection.

In one optional embodiment, the spindle transmission assembly (1.3 and 1.4) includes: a spindle rotating part 1.3 and a spindle toggling sheet 1.4.

In one optional embodiment, the spindle rotating part 1.3 may be used individually, and the spindle rotating part 1.3 and the rotary cylinder housing 1.1 are detachably connected.

In one optional embodiment, the spindle rotating part 1.3 may also be detachably connected to other objects and then be connected to the spindle toggling sheet 1.4.

In one optional embodiment, a shape of the spindle rotating part 1.3 may be any one of a strip shape, a square shape, a diamond shape, a conical shape, a trapezoidal shape, a rod shape, a spherical shape, a needle shape, a triangular shape and a column shape.

In one optional embodiment, a connection structure of the spindle rotating part 1.3 and the rotary cylinder housing 1.1 may be any one of a plug type structure, a screw cap type structure, a lever type structure, a plug-pin type structure, a chain type structure, a stop opening type structure, a clamping opening type structure, a thimble type structure, a gear type structure and a screw fastening type structure.

In one optional embodiment, the spindle toggling sheet 1.4 may be of different shapes and may be detachably and fixedly connected to the spindle rotating part 1.3 directly.

In one optional embodiment, a connection structure of a spindle toggling sheet 1.4 and a spindle rotating part 1.3 may be any one of an abutting type structure, a plug type structure, a screw cap type structure, a lever type structure, a plug-pin type structure, a chain type structure, a stop opening type structure, a clamping opening type structure, a thimble type structure, a gear type structure and a screw fastening type structure.

In one optional embodiment, a shape of the spindle toggling sheet 1.4 when the spindle toggling sheet 1.4 drives the latch toggling sleeve 2.2 may be any one of a strip shape, a rectangular shape, a square shape, a round shape, a conical shape, a trapezoidal shape, a rod shape, a spherical shape, a needle shape, a triangular shape and a column shape.

In one optional embodiment, a connection mode when the spindle toggling sheet 1.4 drives the latch toggling sleeve 2.2 may be any one of a penetrating type structure, a thimble structure, a rubbing and clinging structure, a lever prizing structure, a bearing structure, a force return structure, a zipper structure and a gear structure; and a driving mode when the spindle toggling sheet 1.4 drives the latch toggling sleeve 2.2 may be any one of a push-out type, a sliding type, a bouncing type, a prizing type, a push type, a pull type, a rotating type, a toggling type, a toggling tooth type, a zipper type, a gear type and a twisting type.

In the present invention, through the rotary body 1.2, the rotary knob may continuously rotate under the continuous action of an external twisting force, so as to drive the spindle to rotate; and through a driving torque of the spindle, the bolt can be driven to move close to a direction of a lockhole to complete dead-locking operation.

It should be understood that the above specific embodiments of the present invention are only used to exemplarily illustrate and interpret the principle of the present invention, but do not constitute a limitation to the present invention. Therefore, any modifications, equivalent substitutions, improvements and the like made without departing from the spirit and scope of the present invention should be included within the protection scope of the present invention. In addition, the appended claims of the present invention are intended to cover all changes and modifications that fall within the scope and boundary of the appended claims or equivalent forms of the scope and boundary.

What is claimed is:

1. A rotary cylinder assembly, wherein the rotary cylinder assembly (1) is arranged on one side of a latch (2) or is used individually and includes: a spindle transmission assembly (1.3 and 1.4), arranged at one side of the latch (2) or one part of a to-be-locked object; and a rotary cylinder housing assembly (1.1 and 1.2), arranged at the other end of the spindle transmission assembly (1.3 and 1.4) and configured to drive the spindle transmission assembly (1.3 and 1.4) under an external force to rotate and drive a latch toggling sleeve (2.2) or a toggling sheet(1.4) to hook or clamp a certain fixed part of the to-be-locked object.

2. The rotary cylinder assembly according to claim 1, wherein the rotary cylinder assembly (1) includes: a rotary cylinder housing assembly (1.1 and 1.2) and a spindle transmission assembly (1.3 and 1.4).

3. The rotary cylinder assembly (1) according to claim 1, wherein the rotary cylinder assembly is used together with the latch (2) to toggle the latch toggling sleeve by the toggling sheet (1.4) to drive the bolt to extend to lock the door; and the rotary cylinder assembly is used individually to clamp or hook a certain part of the fixed part of the locked object by the toggling sheet (1.4) without the latch to realize a dead-locking function.

4. The rotary cylinder assembly (1) according to claim 1, wherein the rotary cylinder housing assembly further includes: a rotary cylinder housing (1.1), arranged at one end of a spindle rotating part (1.3) and detachably and fixedly connected to a rotary body (1.2).

5. The rotary cylinder assembly (1) according to claim 1, wherein a rotary cylinder housing (1.1) is used individually and may also be detachably and fixedly connected to other one or more objects to form the rotary cylinder housing assembly for use.

6. The rotary cylinder assembly (1) according to claim 1, wherein a structure of a rotary body (1.2) is any one of a rotary knob structure, a button structure, a handle structure, a pull handle structure, a lever structure, a gear structure and a zipper structure; and a shape of the rotary body (1.2) is any one of a square shape, a round shape, a conical shape, a trapezoidal shape, a rod shape, a spherical shape, a needle shape, a triangular shape and a column shape.

7. The rotary cylinder assembly (1) according to claim 1, wherein a rotary body (1.2) and a rotary cylinder housing (1.1) are in the form of a detachable connection structure, and a structure is any one of plug type structure connection, lever type structure connection, plug-pin type structure connection, chain type structure connection, screw fastening type connection, buckling type structure connection and hook type structure connection.

8. The rotary cylinder assembly (1) according to claim 1, wherein the spindle transmission assembly (1.3 and 1.4) includes: a spindle rotating part (1.3) and a spindle toggling sheet (1.4).

9. The rotary cylinder assembly (1) according to claim 1, wherein a spindle rotating head (1.3) is used individually and may also be detachably and fixedly connected to other one or more transmission objects to form the spindle transmission assembly for use.

10. The rotary cylinder assembly (1) according to claim 1, wherein a spindle rotating part (1.3) and a rotary cylinder housing (1.1) are detachably connected; and a connection structure of the spindle rotating part (1.3) and the rotary cylinder housing (1.1) is any one of a plug type structure, a screw cap type structure, a lever type structure, a plug-pin type structure, a chain type structure, a stop opening type structure, a clamping opening type structure, a thimble type structure, a gear type structure and a screw fastening type structure.

11. The rotary cylinder assembly (1) according to claim 1, wherein a spindle rotating part (1.3) is also detachably connected to other objects and then be connected to a spindle toggling sheet (1.4), or connected to the spindle toggling sheet (1.4) and then connected to other objects to form the spindle transmission assembly.

12. The rotary cylinder assembly (1) according to claim 1, wherein a shape of a spindle rotating part (1.3) is any one of a strip shape, a square shape, a diamond shape, a conical shape, a trapezoidal shape, a rod shape, a spherical shape, a needle shape, a triangular shape, a column shape, an L shape, a snake shape, a wave shape, a hook shape and a barb shape.

13. The rotary cylinder assembly (1) according to claim 1, wherein a spindle toggling sheet (1.4) is of different shapes, and is detachably and fixedly connected to a spindle rotating part (1.3) directly and be detachably and fixedly connected to the spindle rotating part (1.3) indirectly.

14. The rotary cylinder assembly (1) according to claim 1, wherein a connection structure of a spindle toggling sheet (1.4) and a spindle rotating part (1.3) is any one of an abutting type structure, a plug type structure, a screw cap type structure, a lever type structure, a plug-pin type structure, a chain type structure, a stop opening type structure, a clamping opening type structure, a thimble type structure, a gear type structure and a screw fastening type structure.

15. The rotary cylinder assembly (1) according to claim 1, wherein a structure of a toggling tooth of a spindle toggling sheet (1.4) is any one of a strip shape, a rectangular shape, a square shape, a round shape, a conical shape, a trapezoidal shape, a rod shape, a spherical shape, a needle shape, a triangular shape and a column shape.

16. A rotary cylinder assembly (1) according to claim 1, wherein a connection mode when the spindle toggling sheet (1.4) drives the latch toggling sleeve (2.2) or drives a toggling sheet of the spindle transmission assembly to directly hook or clamp a certain fixed part of a to-be-locked object, is any one of a penetrating type structure, a thimble structure, a rubbing and clinging structure, a lever prizing structure, a bearing structure, a force return structure, a zipper structure, a gear structure and an abutting structure; and a driving mode when the spindle toggling sheet (1.4) drives the latch toggling sleeve (2.2) is any one of a push-out type, a sliding type, a bouncing type, a prizing type, a push type, a pull type, a rotating type, a toggling type, a toggling tooth type, a zipper type, a gear type and a twisting type.
